(19) United States
(12) Patent Application Publication
(10) Pub. No.: US 2015/0032545 A1
(43) Pub. Date: Jan. 29, 2015

(54) ADVERTISEMENT PROVIDING METHOD, DEVICE, SYSTEM AND COMPUTER STORAGE MEDIUM BASED ON GEOGRAPHIC LOCATION

(71) Applicant: TENCENT TECHNOLOGY (SHENZHEN) COMPANY LIMITED, Shenzhen, Guangdong (CN)

(72) Inventor: Peixuan Chen, Shenzhen (CN)

(73) Assignee: TENCENT TECHNOLOGY (SHENZHEN) COMPANY LIMITED, Shenzhen, Guangdong (CN)

(21) Appl. No.: 14/384,086

(22) PCT Filed: Mar. 7, 2013
(86) PCT No.: PCT/CN2013/072276

§ 371 Date: Sep. 9, 2014

(30) Foreign Application Priority Data
Mar. 12, 2012 (CN) 201210063523.1

(51) Int. Cl. G06Q 30/02

(52) U.S. Cl. CPC G06Q 30/0261
USPC 705/14.58

(57) ABSTRACT

A method, apparatus, system and computer storage medium for providing an advertisement based on a geographical location are provided according to the present disclosure. The method includes: receiving an advertisement publishing request transmitted from a first user terminal, obtaining geographical location information of the first user terminal, storing the geographical location information of the first user terminal and advertisement information of the first user terminal carried in the advertisement publishing request; receiving a surrounding information searching request transmitted from a second user terminal, obtaining geographical location information of the second user terminal, searching for one or more first user terminals locating around the second user terminal according to the geographical location information of the second user terminal, providing advertisement information of the one or more first user terminals searched out to the second user terminal.

### CROSS-REFERENCE TO RELATED APPLICATIONS

This application is a U.S. National Phase application under 35 U.S.C. §371 of International Application No. PCT/CN2013/072276, filed Mar. 7, 2013, entitled “Method, Apparatus, System and Computer Storage Medium for Providing Advertisement Based On Geographical Location”, the entire contents of which are incorporated herein by reference.

### FIELD OF THE INVENTION

The present disclosure relates to communication technical fields, and more particularly, to a method, apparatus, system and computer storage medium for providing an advertisement based on a geographical location.

### BACKGROUND OF THE INVENTION

Advertisements, as a method for disseminating information, play an important role in a social life, and are bridges for transmitting information between consumers (advertising message recipients) and businesses (advertising information publishers). For the consumers, they are more interesting in advertisement information, e.g., restaurant promotions, discount shopping, of the businesses at geographical locations around geographical locations of them. In a conventional technology, in a large amount of information provided to the consumers, geographical locations of a part of the businesses corresponding to the information are far from current geographical locations of the consumers. And the consumers may not go to the businesses far away from the consumers. Thus, the consumers are not interesting in the advertisement information respectively corresponding to the part of the consumers. Thus, the advertisement information corresponding to the part of the consumers is useless for the consumers. But in order to obtain the useless advertisement information from a network, user terminals of the consumers will consume much flow. Moreover, the consumers have to search for the advertisement information of the businesses around the geographical locations of the consumers. Thus, user experience will be bad.

### SUMMARY OF THE INVENTION

A method for providing an advertisement based on a geographical location is provided according to an example of the present disclosure, which can provide information to an advertisement information receiver around an advertisement information publisher publishing the information.

The method for providing an advertisement based on a geographical location includes:

receiving an advertisement publishing request transmitted from a first user terminal, obtaining geographical location information of the first user terminal, storing the geographical location information of the first user terminal and advertisement information of the first user terminal carried in the advertisement publishing request;

receiving a surrounding information searching request transmitted from a second user terminal, obtaining geographical location information of the second user terminal, searching for one or more first user terminals locating around the second user terminal according to the geographical location information of the second user terminal, providing advertisement information of the one or more first user terminals searched out to the second user terminal.

An apparatus for providing an advertisement based on a geographical location is provided according to an example of the present disclosure, which includes a receiving module, a location obtaining module, an advertisement storing module and an advertisement providing module.

The receiving module is to receive an advertisement publishing request, and receive a surrounding information searching request.

The location obtaining module is to obtain geographical location information of a user terminal.

The advertisement storing module is to after the receiving module receives the advertisement publishing request and the location obtaining module obtains the geographical location information of a first user terminal transmitting the advertisement publishing request, store the geographical location information of the first user terminal and advertisement information of the first user terminal carried in the advertisement publishing request.

The advertisement providing module is to after the receiving module receives the surrounding information searching request and the location obtaining module obtains the geographical location information of a second user terminal transmitting the surrounding information searching request, search for one or more first user terminals locating around the second user terminal according to the geographical location information of the second user terminal, and provide advertisement information of the one or more first user terminals searched out to the second user terminal.

A system for providing an advertisement based on a geographical location is provided according to an example of the present disclosure, which includes a first user terminal, a second user terminal and a server.

The first user terminal is to transmit an advertisement publishing request to a server.

The second user terminal is to transmit a surrounding information searching request to the server.

The server is to receive the advertisement publishing request transmitted from the first user terminal, obtain geographical location information of the first user terminal, store the geographical location information of the first user terminal and advertisement information of the first user terminal carried in the advertisement publishing request, receive the surrounding information searching request transmitted from the second user terminal, obtain geographical location information of the second user terminal, search for one or more first user terminals locating around the second user terminal according to the geographical location information of the second user terminal, provide advertisement information of the one or more first user terminals searched out to the second user terminal.

A computer storage medium is provided for storing instructions for a computer to execute the method above.

It can be seen from the technical solution above that, in the present disclosure, advertisement information is bounded together with a geographical location of an advertisement information publisher. When an advertisement information receiver queries advertisement information around the advertisement information receiver, the advertisement information of the advertisement information publisher around the advertisement information receiver is provided to the advertisement information receiver. Thus, advertisement information can be provided to an advertisement information receiver according to a geographical location of the advertisement information receiver. Moreover, the method can be easily implemented.

### BRIEF DESCRIPTION OF DRAWINGS

FIG. 1 is a flowchart illustrating a method for providing an advertisement based on a geographical location in accordance with an example of the present disclosure;

FIG. 2 is a schematic diagram illustrating a structure of an apparatus of providing an advertisement based on a geographical location in accordance with an example of the present disclosure;

FIG. 3 is a schematic diagram illustrating a structure of a system of providing an advertisement based on a geographical location in accordance with an example of the present disclosure.

### DETAILED DESCRIPTION OF THE INVENTION

In order to make the object, technical solution and merits of the present invention clearer, the present invention will be illustrated in detail hereinafter with reference to the accompanying drawings and specific examples.

A consumption region of a consumer is closely related to a geographical location where the consumer locates. If advertisement information of a business may be provided to the consumer based on the geographical location, an actual requirement of the consumer and the business may be satisfied.

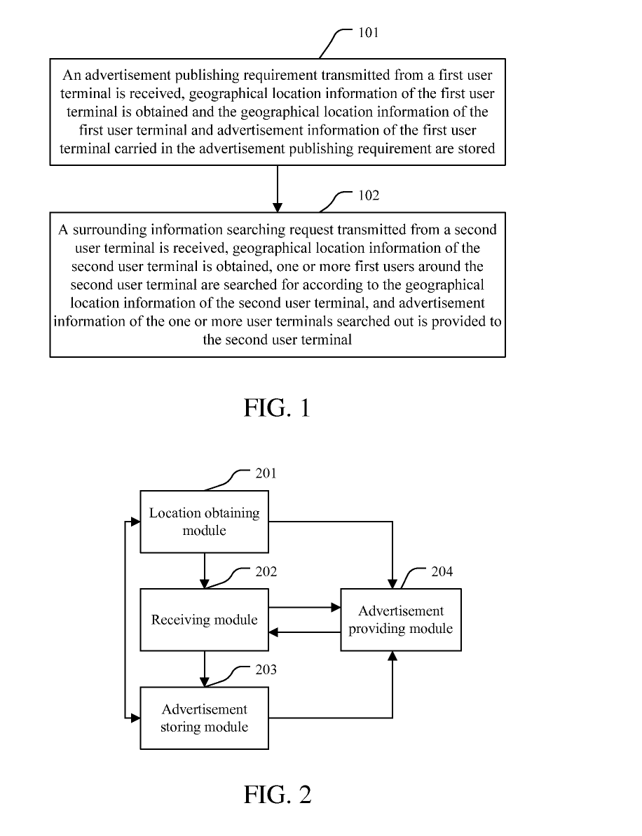

FIG. 1 is a flowchart illustrating a method for providing an advertisement based on a geographical location in accordance with an example of the present disclosure. The method includes procedures as follows.

At block 101, an advertisement publishing requirement transmitted from a first user terminal is received, geographical location information of the first user terminal is obtained and the geographical location information of the first user terminal and advertisement information of the first user terminal carried in the advertisement publishing requirement are stored, wherein the first user terminal is an advertisement information publisher.

At block 102, a surrounding information searching request transmitted from a second user terminal is received, geographical location information of the second user terminal is obtained, one or more first users around the second user terminal are searched for according to the geographical location information of the second user terminal, and advertisement information of the one or more user terminals searched out is provided to the second user terminal, wherein the second user terminal is an advertisement information receiver.

In a practical application, there are some ways for obtaining geographical location information of a user terminal. In an example, when the user terminal is a mobile terminal, the advertisement location information of the user terminal is obtained through a position system for positioning a geographical location of a user terminal such as a Global Positioning System (GPS), a Beidou positioning system. In another example, advertisement location information corresponding to each IP address may be pre-stored. When the user terminal is a terminal not moved, the geographical location information may be obtained according to the IP address of the user terminal.

In the example of the present disclosure as shown in FIG. 1, after a social networking platform is logged on to, a user terminal may be the advertisement information publisher to publish advertisement information, e.g., sales promotion information, discounting information, to attract customers. Moreover, the user terminal may also be the advertisement information receiver to search for the surrounding advertisement information.

When the user terminal is to publish the advertisement information in the social networking platform as the advertisement information publisher, the user terminal may transmit the advertisement publishing request carrying the advertisement information, wherein the user terminal may be the first user terminal. In an example, a user logs on to the social networking platform through the user terminal, fills in the advertisement information in an advertisement publishing webpage provided by the social networking platform, and submits the advertisement information. The first user terminal adds the advertisement information filled in by the user to the advertisement publishing request and transmits the advertisement publishing request, transmits the advertisement publishing request to a server for providing an advertising service in the social networking platform. When receiving the advertisement publishing request transmitted by the first user terminal, the server stores the advertisement information carried in the advertisement publishing request. In addition, the geographical location information of the first user terminal may be obtained and stored, so as to provide the advertisement information to user terminals in the social networking platform based on the geographical location.

When the user terminal is to search for surrounding advertisement information as the advertisement information receiver, the user terminal may transmit the surrounding information searching request, wherein the user terminal is the second user terminal. In an example, the user logs on to the social networking platform, inputs an advertisement searching word in an advertisement searching webpage provided by the social networking platform, and submits the advertisement searching word. The second user terminal adds the advertisement searching word inputted by the user to the surrounding information searching request, transmits the surrounding information searching request to the server for providing the advertising service in the social networking platform. After receiving the surrounding information searching request transmitted from the second user terminal, the server may obtain the geographical location information of the second user terminal, may determine one or more first user terminals around the second user terminal through respectively comparing geographical location information of various first user terminals stored with the geographical location information of the second user terminal stored.

A method that the one or more first user terminals around the second user terminal are searched for according to the geographical location information of the second user terminal and the advertisement information of the one or more user terminals searched out is transmitted to the second user terminal may include: respectively determining whether various first user terminals are around the second user terminal according to geographical location information of the various first user terminals and the geographical location information of the second user terminal, transmitting the advertisement information of one or more first user terminals to the second user terminal when the one or more first user terminals are around the second user terminal. Determining whether a first user terminal locates around a second user terminal may be based on a distance between the first user terminal and the second user terminal. In an example, if a geographical location of the first user terminal is in a region a center of which is a geographical location of the second user terminal and a radius of which is a preset distance value, the first user terminal is determined as the first user terminal around the second user terminal. In another example, if the first user terminal and the second user terminal locate at the same region, e.g., a same city, the first user terminal is determined as the first user terminal around the second user terminal.

In the example as shown in FIG. 1, when the first user terminal transmits the advertisement publishing request, an advertisement providing way may be configured. The first user terminal adds the configured advertisement providing way in the advertisement publishing request. When the geographical location information of the first user terminal and the advertisement information of the first user terminal carried in the advertisement publishing request are stored, the advertisement providing way may also be stored. The advertisement providing way includes a designated location providing way and a mobile location providing way.

The designated location providing way may be providing advertisement information of a first user terminal to a second user terminal in a designated region. The designated region is related with the geographical location information of the first user terminal which is obtained when the advertisement publishing request is received. In an example, the designated region may be a region the center of which is a geographical location corresponding to the geographical location information of the first user terminal when the advertisement publishing request is received, and the radius of which is a preset value. In another example, the designated region may also a region where the first user terminal locates. The region where the first user terminal locates may be obtained when the advertisement publishing request is received. Thus, the designated region may not be changed according to the geographical location of the first user terminal. In an example, the first user terminal transmits the advertisement publishing request to the server at an address A. If the advertisement providing way carried in the request is the designated providing way, the advertisement information is provided to the second user terminal around the address A. If a geographical location of the second user terminal is not around the address A, the advertisement information may not be provided to the second user terminal. Moreover, when the geographical location of the second user terminal is changed to an address B, the advertisement information carried in the request is provided to the second user terminal which locates around the address A and transmits the surrounding information searching request, but is not provided to the second user terminal that locates around the address B and transmits the surrounding information searching request. The server may be a hardware device for providing the social networking platform.

The mobile location providing way may be providing advertisement information of a first user terminal to a second user terminal in a region which is changed according to a geographical location of the first user terminal transmitting an advertisement publishing request carrying advertisement information. For example, the first user terminal transmits the advertisement publishing request to the server at an address A. The advertisement providing way carried in the advertisement publishing request is the mobile location providing way. When the first user terminal moves to an address B, the advertisement information carried in the request may be provided to the second user terminal which locates around the address B and transmits the surrounding information searching request, and may not be provided the second user terminal which locates around the address A and transmits the surrounding information searching request. The server may be a hardware device for providing the social networking platform. In addition, when the advertisement providing way is the mobile location providing way, the stored geographical location information of the first user terminal is to be modified if the geographical location of the first user terminal is change.

In the example of the present disclosure as shown in FIG. 1, the first user terminal has transmitted the advertisement publishing request carrying the advertisement information and the advertisement providing way, the advertisement providing way of the advertisement information is the mobile location providing way. If the geographical location information of the first user terminal newly obtained is different from the stored geographical location information of the first user terminal, the stored the geographical location information of the first user terminal is modified with the geographical location information of the first user terminal newly obtained. For example, the first user terminal S transmits the advertisement publishing carrying the mobile location providing way as the advertisement providing way at an address A. Afterwards, the first user terminal S logs on to the social networking platform based on a geographical location at an address B, the server providing an advertisement service in the social networking platform may modify the stored address A of the first user terminal S to the address B. Thus, the advertisement information of the first user terminal S may be provided for the second user terminal around the address B. The server may be a hardware device for providing the social networking platform.

In an example, searching activities of user terminals and searching conditions related with the advertisement information may be recorded or added up in a log. For example, the number of times that advertisement information is searched out is added up. When the advertisement publishing request transmitted by the first user terminal is received, a parameter of the number of times of searching out the advertisement information carried in the advertisement publishing request may be configured as zero. When the advertisement information of the first user terminal is provided to the second user terminal, the number of times of searching out the advertisement information is added up.

After the advertisement information of the first user terminal is provided to the second user terminal, the second user terminal may comment the advertisement information by transmitting an advertisement information commenting request. In an example, advertisement comment information may be about quality of a commodity. In another example, if commodity price information or discounting information is related to in the advertisement information, an actual condition of a commodity price or discounting may be commented. The advertisement comment information may be added into the advertisement information commenting request, and may be transmitted to a server. In addition, the second user terminal may request to obtain advertisement comment information corresponding to the advertisement information from other user terminals through transmitting an advertisement information comment querying request carrying the advertisement information. The server may be a hardware device for providing the social networking platform.

When receiving the advertisement information commenting request from the second user terminal, the server may store the advertisement comment information corresponding to the advertisement information carried in the advertisement information commenting request. When receiving the advertisement information comment querying request from the second user terminal, the advertisement comment information corresponding to the advertisement information carried in the advertisement information comment querying request is transmitted to the second user terminal. Thus, the second user terminal may know quality of a commodity corresponding to the advertisement information or authenticity of the advertisement information.

In examples above, a method for providing an advertisement based on a geographical location has been described in detail. An apparatus for providing an advertisement based on a geographical location is also provided according to an example of the present disclosure.

FIG. 2 is a schematic diagram illustrating a structure of an apparatus of providing an advertisement based on a geographical location in accordance with an example of the present disclosure. The apparatus includes a location obtaining module 201, a receiving module 202, an advertisement storing module 203, an advertisement providing module 204.

The location obtaining module 201 is configured to obtain geographical location information of a user terminal.

The receiving module 202 is configured to receive an advertisement publishing request transmitted from a user terminal as an information publisher, and receive a surrounding information searching request transmitted for a user terminal as an information receiver.

The advertisement storing module 203 is configured to after the receiving module 202 receives the advertisement publishing request transmitted from the first user terminal and the location obtaining module 201 obtains geographical location information of the first user terminal, store the geographical location information of the first user terminal and advertisement information of the first user terminal carried in the advertisement publishing request

The advertisement providing module 204 is configured to after the receiving module 202 receives the surrounding information searching request from the second user and the location obtaining module 201 obtains geographical location information of the second user terminal, search for one or more first user terminals locating around the second user terminal according to the geographical location information of the second user terminal, and provide advertisement information of the one or more first user terminals searched out to the second user terminal.

The advertisement publishing request further carries an advertisement providing way of the first user terminal, wherein the advertisement providing way comprises a designated location providing way and a mobile location providing way.

The advertisement storing module 203 is further configured to store advertisement providing way of the first user terminal when the geographical location information of the first user terminal and the advertisement information of the first user terminal carried in the advertisement publishing request are stored.

The location obtaining module 201 is further configured to after newly obtaining geographical location information of the first user terminal, modify the geographical location information of the first user terminal stored in the advertisement storing module 203 with the geographical location information of the first user terminal newly obtained when the stored advertisement providing way of the first user terminal is the mobile location providing way and the geographical location information of the first user terminal newly obtained is different from the geographical location information of the first user terminal stored in the advertisement storing module 203.

The advertisement providing module 204 is configured to when the one or more user terminals are searched for according to the geographical location information of the second user terminal, the one or more user terminals searched out are provided to the second user terminal, determine respectively whether various first user terminals locate around the second user terminal according to geographical location information of the various first user terminals and the geographical location information of the second user terminal stored in the advertisement storing module 203, provide the advertisement information of the one or more first user terminals to the second user terminal if the one or more first user terminals are around the second user terminal.

The advertisement providing module 204 is further configured to when the advertisement information of the one or more first user terminals is provided to the second user terminal, add up respectively the numbers of times of searching out the advertisement information of the one or more first user terminals.

The receiving module 202 is further configured to after the advertisement providing module 204 provides the advertisement information of the one or more first user terminals to the second user terminal, receive an advertisement information commenting request from the second user terminal and an advertisement information comment querying request from the second user terminal.

The advertisement storing module 203 is further configured to store advertisement comment information corresponding to advertisement information carried in the advertisement information commenting request after the receiving module 202 receives the advertisement information commenting request transmitted from the second user terminal.

The advertisement providing module 204 is further configured to provide advertisement comment information stored in the advertisement storing module 203 corresponding to advertisement information carried in the advertisement information commenting query request to the second user terminal after the receiving module 202 receives the advertisement information comment querying request transmitted from the second user terminal.

The apparatus may be a server implemented through a computer. The server is a hardware device for providing a social networking platform, e.g., a server for providing an advertisement service of the social networking platform, or a server for providing an advertisement service of the social geographical location platform.

Through the method and apparatus above, a network device can provide information to a user terminal locating around a user terminal publishing the information. Thus, it is avoided to provide information to a user terminal far from the user terminal publishing the information, wherein the information is unless for the user terminal far from the user terminal publishing the information. Moreover, data flow is saved in a system.

A system for providing an advertisement based on a geographical location is provided according to an example of the present disclosure.

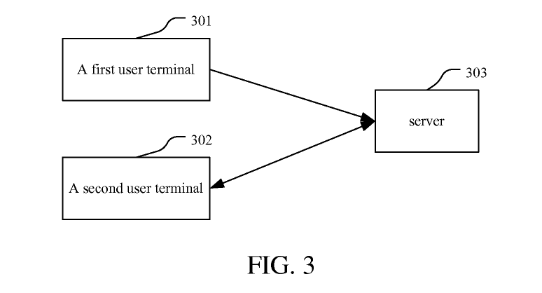

FIG. 3 is a schematic diagram illustrating a structure of a system of providing an advertisement based on a geographical location in accordance with an example of the present disclosure. The system includes a first user terminal 301, a second user terminal 302, a server 303. The first user terminal 301 may be a same user terminal with the second user terminal 302, or may be a different user terminal from the second user terminal 302. The server 302 is a hardware device for providing a social networking platform, may be implement through a computer.

The first user terminal 301 is configured to transmit an advertisement publishing request to a server.

The second user terminal 302 is configured to transmit a surrounding information searching request to the server.

The server 303 is configured to receive the advertisement publishing request transmitted from the first user terminal 301, obtain geographical location information of the first user terminal, store the geographical location information of the first user terminal and advertisement information of the first user terminal carried in the advertisement publishing request, receive the surrounding information searching request transmitted from the second user terminal 302, obtain geographical location information of the second user terminal, search for one or more first user terminals 301 locating around the second user terminal according to the geographical location information of the second user terminal, provide advertisement information of the one or more first user terminals 301 searched out to the second user terminal 302.

The advertisement publishing request transmitted from the first user terminal 301 further carries an advertisement providing way of the first user terminal, wherein the advertisement providing way comprises a designated location providing way and a mobile location providing way.

The server 303 is further configured to after geographical location information of the first user terminal is newly obtained, modify the stored geographical location information of the first user terminal with the newly-obtained geographical location information of the first user terminal if the advertisement publishing request is received, the advertisement providing way carried in the received advertisement publishing request is the mobile location providing way and the newly-obtained geographical location information of the first user terminal is different from the stored geographical location information of the first user terminal.

The server 303 is configured to when the one or more first user terminals 301 are searched for according to the geographical location information of the second user terminal 302 and the advertisement of the one or more first user terminals 301 searched out is provided to the second user terminal 302, determine respectively whether various first user terminals 301 locate around the second user terminal 302 according to stored geographical location information of the various first user terminals 301 and the stored geographical location information of the second user terminal 302, and provide the advertisement information of the one or more first user terminals 301 to the second user terminal 302 if the one or more first user terminals 301 are around the second user terminal 302.

The server 303 is further configured to when the advertisement information of the one or more first user terminals 301 is provided to the second user terminal 302, add up respectively the numbers of times of searching out the advertisement information of the one or more first user terminals 301.

The server 303 is further configured to after the advertisement information of the one or more first user terminals 301 is provided to the second user terminal 302, store advertisement comment information corresponding to advertisement information carried in an advertisement information commenting request when the advertisement information commenting request from the second user terminal 302 is received; and provide advertisement comment information corresponding to advertisement information carried in an advertisement information commenting query request to the second user terminal when the advertisement information comment querying request from the second user terminal 302 is received.

The first user terminal or the second user terminal may be a mobile terminal, e.g., a phone, a Laptop, a tablet PC, a point of sale (POS) machine, an on-board computer, may also be a terminal not moved, e.g. a Desktop PC.

Based on the technical solution provided according to examples of the present disclosure, a machine readable storage medium is provided to store instructions for a machine to execute a method for providing an advertisement based on a geographical location In detail, a system or an apparatus with a storage medium may be provided. Codes of software program for executing functions of any of examples of the present disclosure, so that a computer (or a CPU or a MPU) in the system or the apparatus reads and execute the codes of the program stored in the storage medium.

In this condition, the codes of the program read from the storage medium may implement functions of any of examples. Thus, the codes of the program and the storage medium storing the codes of the program are a part to implement the technical solution for providing an advertisement based on a geographical location.

In an example, the storage medium for storing the codes of the program includes a floppy disk, a hard disk, a magneto-optical disk, an optical disk (e.g., CD-ROM, CD-R, CD-RW, DVD-ROM, DVD-RAM, DVD−RW, DVD+RW), a magnetic tape, a nonvolatile memory card, and ROM. Optionally, the codes of the program may be downloaded from a computer as a server through a communication network.

In addition, it should be noted that all or part of practical operations may be implemented by executing the codes of the program read by the computer. Alternatively, an operating system in a computer can be indicated to implement all or part of practical operations through instructions based on the codes of the program. Thus, functions of any of examples above according to the present disclosure can be implemented.

In addition, it should be noted that the codes of the program read from the storage medium may be written into memory in an expansion board inserted into the computer or may be written into memory in an expansion unit connected with the computer, afterwards, the instructions based on the codes of the program may make a CPU installed in the expansion board or an expansion unit execute all or part of practical operations. According to examples above of the present disclosure, based on geographical location information of an advertisement information publisher and an advertisement information receiver, it is implemented for efficiently disseminating advertisement information, network transmission performance is improved, and user experience is enhanced. In detail, the advertisement information publisher publishes advertisement information based on the geographical location information of the advertisement information publisher. Thus, a requirement for a marketing capability of a service provider of a social networking platform is reduced, and the advertisement information publisher and the advertisement information receiver are bounded together seamlessly. In addition, after obtaining advertisement information of the advertisement information publisher around the advertisement information receiver, the advertisement information receiver can comment the advertisement information of the advertisement information publisher. Thus, the advertisement information publisher can be supervised, the false or exaggerated advertisement information can be combated effectively, and audit for the advertisement information published by the advertisement information publisher can be reduced for the service provider of the social networking platform. The foregoing is only preferred examples of the present invention and is not used to limit the protection scope of the present invention. Any modification, equivalent substitution and improvement without departing from the spirit and principle of the present invention are within the protection scope of the present invention.

1. A method for providing an advertisement based on a geographical location, comprising:
receiving an advertisement publishing request transmitted from a first user terminal, obtaining geographical location information of the first user terminal, storing the geographical location information of the first user terminal and advertisement information of the first user terminal carried in the advertisement publishing request;
receiving a surrounding information searching request transmitted from a second user terminal, obtaining geographical location information of the second user terminal, searching for one or more first user terminals locating around the second user terminal according to the geographical location information of the second user terminal, providing advertisement information of the one or more first user terminals searched out to the second user terminal;
wherein the advertisement publishing request further carries an advertisement providing way of the first user terminal, wherein the advertisement providing way comprises a designated location providing way and a mobile location providing way.

2. (canceled)

3. The method of claim 1, further comprising:
after obtaining geographical location information of the first user terminal, modifying the stored geographical location information of the first user terminal with the newly-obtained geographical location information of the first user terminal if the advertisement providing way carried in the received advertisement publishing request is the mobile location providing way and the newly-obtained geographical location information of the first user terminal is different from the stored geographical location information of the first user terminal.

4. The method of claim 3, wherein searching for the one or more first user terminals locating around the second user terminal according to the geographical location information of the second user terminal, providing the advertisement information of the one or more first user terminals searched out to the second user terminal comprises:
determining respectively whether various first user terminals locate around the second user terminal according to stored geographical location information of the various first user terminals and the stored geographical location information of the second user terminal;
providing the advertisement information of the one or more first user terminals to the second user terminal if the one or more first user terminals are around the second user terminal.

5. The method of claim 3, further comprising:
when the advertisement information of the one or more first user terminals searched out is provided to the second user terminal, adding up respectively the numbers of times of searching out the advertisement information of the one or more first user terminals.

6. The method of claim 3, further comprising:
after the advertisement information of the one or more first user terminals is provided to the second user terminal, storing advertisement comment information corresponding to advertisement information carried in an advertisement information commenting request after the advertisement information commenting request from the second user terminal is received;
providing advertisement comment information corresponding to advertisement information carried in an advertisement information commenting query request to the second user terminal after the advertisement information comment querying request from the second user terminal is received.

7. An apparatus for providing an advertisement based on a geographical location, comprising:
a receiving module, configured to receive an advertisement publishing request, and receive a surrounding information searching request;
a location obtaining module, configured to obtain geographical location information of a user terminal;
an advertisement storing module, configured to after the receiving module receives the advertisement publishing request and the location obtaining module obtains the geographical location information of a first user terminal transmitting the advertisement publishing request, store the geographical location information of the first user terminal and advertisement information of the first user terminal carried in the advertisement publishing request;
an advertisement providing module, configured to after the receiving module receives the surrounding information searching request and the location obtaining module obtains the geographical location information of a second user terminal transmitting the surrounding information searching request, search for one or more first user terminals locating around the second user terminal according to the geographical location information of the second user terminal, and provide advertisement information of the one or more first user terminals searched out to the second user terminal;
wherein the advertisement publishing request further carries an advertisement providing way of the first user terminal, wherein the advertisement providing way comprises a designated location providing way and a mobile location providing way;
the advertisement storing module is further configured to store the advertisement providing way of the first user terminal when the geographical location information of the first user terminal and the advertisement information of the first user terminal carried in the advertisement publishing request are stored.

8. (canceled)

9. The apparatus of claim 7, wherein the location obtaining module is further configured to after obtaining geographical location information of the first user terminal, modify the geographical location information of the first user terminal stored in the advertisement storing module with the geographical location information of the first user terminal newly obtained if the stored advertisement providing way of the first user terminal is the mobile location providing way and the geographical location information of the first user terminal newly obtained is different from the geographical location information of the first user terminal stored in the advertisement storing module.

10. The apparatus of claim 9, wherein the advertisement providing module is configured to determine respectively whether various first user terminals locate around the second user terminal according to geographical location information of the various first user terminals and the geographical location information of the second user terminal stored in the advertisement storing module, and provide the advertisement information of the one or more first user terminals to the second user terminal if the one or more first user terminals are around the second user terminal.

11. The apparatus of claim 10, wherein the advertisement providing module is further configured to when the advertisement information of the one or more first user terminals is provided to the second user terminal, add up respectively the numbers of times of searching out the advertisement information of the one or more first user terminals.

12. The apparatus of claim 10, wherein the receiving module is configured to after the advertisement providing module provides the advertisement information of the one or more first user terminals to the second user terminal, receive an advertisement information commenting request and an advertisement information comment querying request;
the advertisement storing module is further configured to store advertisement comment information corresponding to advertisement information carried in the advertisement information commenting request after the receiving module receives the advertisement information commenting request transmitted from the second user terminal;
the advertisement providing module is further configured to provide advertisement comment information stored in the advertisement storing module corresponding to advertisement information carried in the advertisement information commenting query request to the second user terminal after the receiving module receives the advertisement information comment querying request transmitted from the second user terminal.

13. A network communication system for providing an advertisement based on a geographical location, comprising:
a first user terminal, configured to transmit an advertisement publishing request to a server;
a second user terminal, configured to transmit a surrounding information searching request to the server;
the server, configured to receive the advertisement publishing request transmitted from the first user terminal, obtain geographical location information of the first user terminal, store the geographical location information of the first user terminal and advertisement information of the first user terminal carried in the advertisement publishing request, receive the surrounding information searching request transmitted from the second user terminal, obtain geographical location information of the second user terminal, search for one or more first user terminals locating around the second user terminal according to the geographical location information of the second user terminal, provide advertisement information of the one or more first user terminals searched out to the second user terminal;
wherein the advertisement publishing request transmitted from the first user terminal further carries an advertisement providing way of the first user terminal, wherein the advertisement providing way comprises a designated location providing way and a mobile location providing way.

14. (canceled)

15. The system of claim 13, the server is further configured to after geographical location information of the first user terminal is obtained, modify the stored geographical location information of the first user terminal with the newly-obtained geographical location information of the first user terminal if the advertisement providing way carried in the received advertisement publishing request is the mobile location providing way and the newly-obtained geographical location information of the first user terminal is different from the stored geographical location information of the first user terminal.

16. The system of claim 15, the server is configured to determine respectively whether various first user terminals locate around the second user terminal according to stored geographical location information of the various first user terminals and the stored geographical location information of the second user terminal, and provide the advertisement information of the one or more first user terminals to the second user terminal if the one or more first user terminals are around the second user terminal.

17. The system of claim 16, the server is further configured to when the advertisement information of the one or more first user terminals is provided to the second user terminal, add up respectively the numbers of times of searching out the advertisement information of the one or more first user terminals.

18. The system of claim 16, the server is further configured to after the advertisement information of the one or more first user terminals is provided to the second user terminal, store advertisement comment information corresponding to advertisement information carried in an advertisement information commenting request after the advertisement information commenting request from the second user terminal is received; and provide advertisement comment information corresponding to advertisement information carried in an advertisement information commenting query request to the second user terminal after the advertisement information comment querying request from the second user terminal is received.

19. (canceled)
